(19) United States
(12) Patent Application Publication
(10) Pub. No.: US 2011/0215007 A1
(43) Pub. Date: Sep. 8, 2011

(54) CONTAINER OR MOLDED PACKAGE WITH BUFFERING CAPACITY

(76) Inventor: Kenneth Charles Wurtzel, Bridgeton, NJ (US)

(21) Appl. No.: 13/027,567

(22) Filed: Feb. 15, 2011

Related U.S. Application Data
(60) Provisional application No. 61/305,990, filed on Feb. 19, 2010.

(51) Int. Cl. B65D 81/26; B65D 85/00; B29C 47/04

(52) U.S. Cl. 206/204; 206/524.2; 264/513

(57) ABSTRACT

A container for a pH-sensitive product. The container has an openable container body defining an interior volume for holding the product. More specifically, a rigid container defining an interior volume for holding a pH-sensitive product, and comprising at least an inner layer and an outer layer, the inner and outer layers being coextruded layers, the inner layer comprising a polymeric material and a buffer material, the outer layer comprising a moisture-barrier material.

### CROSS-REFERENCE TO RELATED APPLICATIONS

This application claims the benefit of U.S. Provisional Application No. 61/305,990, filed on Feb. 19, 2010. The entire disclosure of the above application is incorporated herein by reference.

### FIELD

The present teachings relate to plastic product packages that provide the ability to buffer products in intimate contact with the packages. More particularly, the present teachings relate to containers or molded packages containing a buffer and to methods for production of such containers.

### BACKGROUND

This section provides background information related to the present disclosure which is not necessarily prior art.

Many medicaments and other ingestible or non-ingestible consumer products are adversely affected if their pH is altered during storage and hence and must be protected against such alterations between production and consumption. The damage may take the form of increasing the alkalinity or acidity that may change the physical or chemical properties of the products perhaps even making the product ineffective for use. When such products are produced and sold in small amounts and in discrete unit form (e.g. pills or tablets), they are often sealed in reclosable containers made of glass or plastics, such as conventional pill or tablet bottles.

Often a desiccant, in the form of a sachet or packet, is added to remove any moisture from the enclosed atmosphere. It is also known to place a desiccant such as calcium oxide (CaO) in a moisture barrier layer in the container itself. For example, the container body is made of a rigid material comprising at least two co-extruded polymer layers, i.e., an inner one comprising a desiccant, and an outer layer comprising a solid, non-porous moisture-barrier material. However, a powdered or other form of desiccant may leach into the product held in the container, particularly if water is present in the container, thus altering the pH of the product and making the product more alkaline.

### SUMMARY

This section provides a general summary of the disclosure, and is not a comprehensive disclosure of its full scope or all of its features.

According to principles of the present teachings, there is provided a container for a pH-sensitive product, comprising: a container body defining an interior volume for holding a pH-sensitive product, wherein the container body is made of a rigid material comprising at least two co-extruded polymer layers, Le., an inner layer comprising a buffer, and an outer layer comprising a solid, non-porous moisture barrier material. In a further aspect a desiccant is also present in the inner layer, or a third layer is present containing a desiccant.

According to principles of the present teachings, there is provided a container for a pH-sensitive product, comprising: a container body defining an interior volume for holding a pH-sensitive product, wherein the container body is made of a rigid material comprising an extruded polymer layer comprising a buffer and a non-porous moisture-barrier material. In a further aspect, a desiccant is also present.

According to principles of the present teachings, there is provided a molded package for holding a pH-sensitive product, comprising: a molded body made of a rigid material comprising at least two polymer layers, Le., an inner layer comprising a buffer, and an outer layer comprising a solid, non-porous moisture-barrier material. In a further aspect a desiccant is also present in the inner layer, or a third layer is present containing a desiccant.

According to principles of the present teachings, there is provided a molded package for holding a pH-sensitive product, comprising: a molded package made of a rigid material comprising: a molded body defining an interior volume for holding a pH sensitive product, wherein the molded body is made of a rigid material comprising a buffer and a non-porous moisture-barrier material. In a further aspect, a desiccant is also present.

Following the present disclosure, it is possible to create a container in which there is an inner layer having a buffer in intimate contact or near intimate contact with any product within the interior volume of the container. The container may have the desired strength and rigidity required for transportation and storage of the contained product.

Also described herein are methods for producing containers for a pH sensitive product.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1a and 1b are a container and exploded wall cross-section according to some embodiments of the present invention.

FIGS. 2a and 2b are a container and exploded wall cross-section according to some embodiments of the present invention.

FIGS. 3a and 3b are a container and exploded wall cross-section according to some embodiments of the present invention.

FIGS. 4a and 4b are a container and exploded wall cross-section according to other embodiments of the present invention.

FIG. 5 is an isometric view of a container according to a further embodiment of the invention.

FIG. 6 is a horizontal cross-section illustration of the embodiment in FIG. 5.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In coextrusion or co-injection methods disclosed herein, a manufacturer can mass produce a container comprising a layer comprising a buffer material, wherein the layer comprising the buffer material can be the inner layer of the container in intimate or near intimate contact with the pH sensitive product to be held within the container, or the buffer layer can be encapsulated near the interior with a protective layer of breathable polymer. In the coextrusion or co-injection methods disclosed herein, a manufacturer can simply coextrude or coinject materials into a mold that corresponds to the container to be formed. In the coextrusion or co-injection methods disclosed herein, a manufacturer can readily switch to making a different sized container by simply using a different mold corresponding to the different sized container, and coextruding or coinjecting the same materials into that subsequently used mold. Methods of production and process included can be coextrusion blow molding, co-injection molding, co-injection blow molding, and/or co-injection stretch blow molding.

Furthermore, the buffer material may be contained within one or more of the layers of the container structure. For example, the buffer may be contained within the inner layer of a structure. The container structure may be utilized to produce containers such as a bottle, a vial, or a package, for example lidstock with a formed sheet cover, for a moisture-sensitive product.

Embodiments of the present teachings incorporate a chemical buffer to counter act or neutralize the effects of other constituents found in the make up of a container. For example, various constituents may affect the contents of a container by making the contents too acidic or too alkaline. The buffer is used to restore or maintain the proper pH of the contents of the container. For example, if a desiccant or desiccant layer (typically CaO) is used in the container, the contents of the container may become too alkaline. Thus the buffer should provide an acid contribution. Suitable buffers may include, but are not limited to, sodium bicarbonate, ethanoic acid, sodium ethanoate, or acetic acid. The buffer should be tailored to the constituent being countered. For example, if the buffer was sodium bicarbonate, then it should be provided as small particles or powder so that it can be dispersed easily throughout the plastic layer to contain it. Additionally, steps should be taken during this compounding of the layer with the buffer so as to not contaminate or deplete the buffering action.

Embodiments of the present invention may also include at least one desiccant. Either or both chemical desiccants and physical desiccants may be used in the same container structure. The use of such desiccants is described in US Publication 20080012172, hereby incorporated by reference in its entirety.

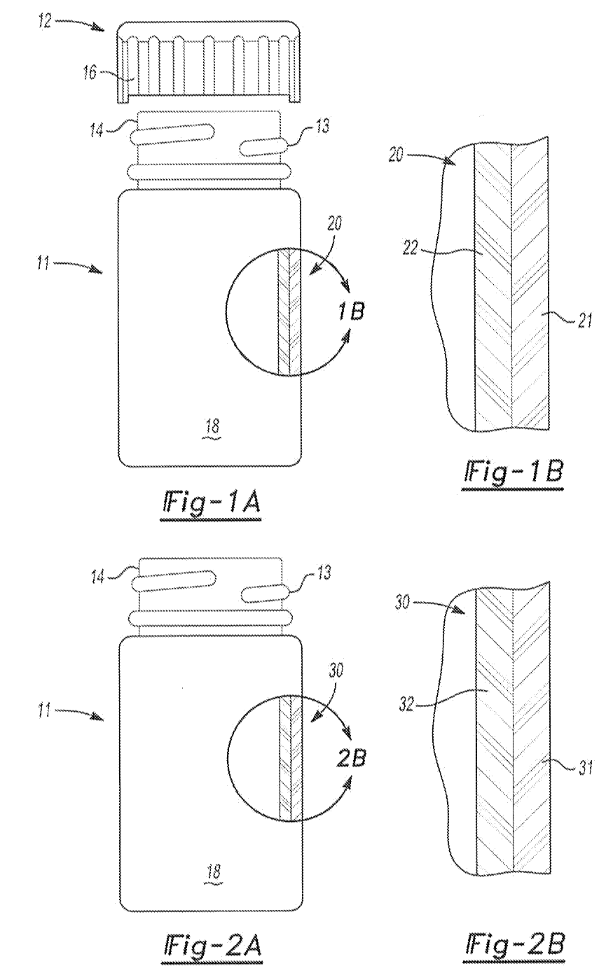

An example of a container 11 for moisture sensitive products is shown in FIG. 1 of the accompanying drawings. Container 11 is in the form of a plastic bottle. While a bottle is shown in FIG. 1, those skilled in the art will recognize that a wide variety of containers can be made in accordance with disclosures herein, including but not limited to bottles, canisters (e.g., canisters for 35 mm film), vials (e.g., vials for pharmaceutical products), etc. A cross-sectional area defined by a neck of the Container can be smaller, larger or the same size as a cross-sectional area defined by the side wall of the container. Container 11 and a closure or lid 12 form a container and lid combination 10. Lid 12 in some embodiments can attach to the container 11 via a screw thread 13 formed on a neck 14 of container 11 that engages with a corresponding thread on an inner surface 15 of a skirt 16 of the lid 12. Container 11 defines an internal volume 18 that encloses the product (not shown) in the completed form of the package. In alternative forms, container 11 can have a different shape or appearance from that shown in FIG. 1. If desired, container and lid combination 10 may be provided in the conventional way with an anti-tamper feature. Such a feature would, of course, have to be removed before the contents could be accessed.

Container 11 can be a rigid, semi-rigid, or flexible container made of multiple layers of plastic resin(s) 20 as shown in FIG. 1a which shows a cross-section of the wall of the container. In some embodiments, the multiple layers of plastic resin(s) can be such that when formed into a container, the container retains its molded shape under gravity (when empty or when filled with product) but, if desired, may be flexible enough to be indented when squeezed by hand. Even when indented by hand, the material can return to its original shape when released, even when the container is open. In some embodiments, the side wall of the container can have a thickness of about 15 mils or greater. In a further embodiment, the side wall of the container can have a thickness of about 15 to 110 mils. In a further embodiment, the side wall of the container can have a thickness of about 103 mils, with an outer layer 21 of the side wall being about 30 mils thick and an inner layer 22 of the side wall being about 73 mils thick. In some embodiments, the density of the side wall can be around 0.888 grams/cc or greater.

Container 11 may preferably be formed by a process called coextrusion or co-injection. Specifically, different layers of material comprising container 11 can be coextruded in a multilayer coextrusion blow molding process, co-injection molding, co-injection blow molding, and/or co-injection stretch blow molding. Other extrusion processes can be used, such as cast and tubular water quench extrusion processes.

While the following discussion focuses on formation of container 11, the same discussion can apply equally to formation of closure or lid 12.

Container 11 may be made of at least two different coextruded layers 21 and 22 of plastic material. Specifically, layers 21 and 22 may be coextruded as a hot molten tube containing the multiple layers 20 of plastic material. Container 11 can then be made from the tube by conventional blow-molding techniques. The layers 21 and 22 may also be co-injection molded into a finished container or that co-injection item, while still hot, may be blow molded into a finished container, dependent upon the desired container shape, using co-injection blow molding or co-injection stretch blow molding techniques.

In some embodiments, polymers for the different layers are extruded separately and then brought together in a die, which co-extrudes them as a multilayer tube. During the manufacturing process, this tube can be located in a mold having cavity portions cut into it which together define the shape of container 11. The cavity portions can be closed onto the multilayer tube by pinching the tube at the top and the bottom to form a sealed tube. The tube can be pierced at the top and air can be injected to inflate the multilayer tube to fit the shape of the cavity of the mold. The mold can be opened and the multilayered container can be removed. The container can be trimmed of flash at the bottom and top where the multilayer tube was pinched shut.

Layer 21, the outer layer of container 11, can be made of any conventional thermoplastic resin material used for containers of this kind. In some embodiments, layer 21 comprises high density polyethylene (HDPE) (e.g., polyethylene having a density of about 0.95 to 0.96 glee and having chains which are virtually linear, that is, virtually no side chain branching), but other extrudable resins may be used, such as cyclic olefin copolymers, polypropylene, other polyethylenes, nylon and polyesters. The resin comprising layer 21 should have a high resistance to penetration by moisture when present in the shaped container. In some embodiments, layer 21 should preferably act as a barrier layer to substantially block the penetration of moisture. This may be assured both by choosing an appropriate resin and also by providing the layer with a suitable thickness.

Layer 22, the inner layer of container 11, can comprise a buffer blended within a resin. The formulation of the resin for layer 22 should be such that it can be extruded in a manner that allows adhesion to an adjoining layer of the container, as well as providing appropriate rheology during melting, processing and forming. Some potential resins for use in layer 22 include linear low density polyethylene, low density polyethylene, polypropylene homopolymers, polypropylene copolymers, polyethylene naphthalate, cellulose acetate butyrate, ethyl cellulose, polycarbonate, nylon, polysulfone, polyether sulfone, polyethylene terephthalate, cyclic olefin homopolymers and cyclic olefin copolymers.

The starting material for layer 22 may also contain a small proportion of a foaming or blowing agent, e.g. a heat-sensitive blowing agent that commences “foaming” of the resin at the time it exits the extruder. Specifically, in those cases where the layer 22 is intended to be provided with open pores in the resin that allow better contact of the desiccant in the layer with the atmosphere within the enclosed volume 18, a blowing agent is incorporated into the resin mixture intended to form the inner layer 22. A blowing agent can be selected that is heat activated at a temperature suitable for the resin co-extrusion step so that the blowing agent forms a gas as the resin mixture is extruded through the die slot. Thus, as layer 22 is formed, the gas can create pores in the resin and the pores can remain in the resin as layer 22 contacts and adheres to layer 21 to form a multiple layer tube which is later molded into container 11. The amount of blowing agent employed in the resin mixture should be appropriate to produce an open-pore structure in container 11 without disintegrating or weakening the resin matrix of layer 22. Normally, the minimum amount of blowing agent that can achieve the desired porosity is employed. This amount depends on the actual blowing agent employed.

Suitable blowing agents for this purpose may be physical or chemical blowing agents. Physical blowing agents undergo only physical change. The most common are low-boiling organic liquids, such as hydrocarbons (normal pentane, iso-pentane and cyclo pentane) and halogenated hydrocarbons, which develop cells within the plastic material by changing from liquid to gas during foaming under the influence of heat. Gases (e.g. nitrogen gas) constitute another group of substances belonging to this class. When physical blowing agents are used in foaming, therefore, the gas phase of the foam is chemically identical with the blowing agent. Chemical blowing agents are materials that are stable at normal storage temperature and under specific processing conditions, but undergo decomposition with controllable gas evolution at reasonably well defined temperatures (or reaction conditions). When they are used in foaming, the gas phase of the resulting foam is different from the blowing agent (usually a solid substance). Blowing agents of this class can be organic nitrogen compounds (e.g., azodicarbonamide), and produce, mainly, nitrogen gas along with smaller proportions of other gases.

The resulting layer 22 can be porous and allow greater contact between the contents of the container and the buffer in the formed layer 22. The type of blowing agent and its concentration in the resin may affect the number of pores formed in the final layer 22 and the size of the pores, so suitable choices can be made to produce a product of the required specifications. The resin used for this layer may be different from the resin used for layer 21, but it may be the same, e.g. a high density polyethylene.

In some embodiments, a buffer can be incorporated into layer 22 at a level of between about 0.0 1 weight percent and about 5 weight percent of the total weight of layer 22. In some embodiments, the buffer may be incorporated into layer 22 at a level of between about 1 weight percent and about 4 weight percent. In some embodiments, the buffer may be incorporated into the layer at a level of between approximately 2 weight percent and approximately 3 weight percent. In some embodiments, the buffer may be incorporated into layer 22 at a level of approximately 2.5 weight percent.

In some embodiments, a buffer and a desiccant is combined into the inner layer. As shown in FIG. 2, layer 31, the outer layer of container 11, can be made of any conventional as described above for outer layer 21 of FIG. 1. Layer 32, the inner layer of container 11, can comprise a buffer and a desiccant blended within a resin in a manner as described above for the combination of the buffer and the desiccant.

As discussed above, the starting material for layer 32 may also contain a small proportion of a foaming or blowing agent, Layer 32 should be minimally exposed to any ambient moist air before, during and after extrusion and blow molding as the desiccant is susceptible to moisture take-up during processing. The nature of the resin and the amount used is preferably such that, in the final container, the resin in layer 32 is permeable to water vapor and moisture so that the desiccant in layer 32 may act to keep the interior of the container dry. By having a desiccant in layer 32, a foil seal, such as a foil induction seal, can be used to provide a seal after product is placed within the open space defined by the container. This decreases or eliminates the need to have a desiccant sachet or desiccant insert placed within the container, and reduces or eliminates the need for a desiccant placed in the lid or cap in order to protect product placed in the container from being adversely effected by moisture.

The desiccant blended into the resin or polymeric material used for layer 32 could be a powdered solid that is mixed with the molten resin before co-extrusion takes place. The amount of desiccant can be sufficient to provide the required drying action in the interior volume 18 of the finished container 11. The ratio of desiccant to resin can be the highest amount that can run successfully in the extrusion and blow molding equipment. The ratio may often range from 5 parts by weight of desiccant to 95 parts by weight of resin, to 80 parts by weight of desiccant to 20 parts by weight of resin. In some embodiments, the ratio can be approximately 10 to 25 parts by weight desiccant to approximately 75 to 90 parts by weight resin. In a particular embodiment, the ratio can be about 50:50 by weight. In some embodiments, the desiccant material can be a Calcium Oxide (CaO) desiccant concentrate.

The buffer is incorporated into layer 32 at a level of between about 0.01 weight percent and about 5 weight percent of the total weight of layer 32. In some embodiments, the buffer may be incorporated into layer 32 at a level of between about 1 weight percent and about 4 weight percent. In some embodiments, the buffer may be incorporated into the layer at a level of between approximately 2 weight percent and approximately 3 weight percent. In an additional embodiment, the buffer may be incorporated into layer 32 at a level of approximately 2.5 weight percent.

The chemical desiccant material is incorporated into layer 32 at a level of between about 1 weight percent and about 60 weight percent of the total weight of layer 32. In some embodiments, the desiccant material may be incorporated into layer 32 at a level of between about 20 weight percent and about 60 weight percent. In some embodiments, the desiccant material may be incorporated into the layer 32 at a level of between approximately 20 weight percent and approximately 40 weight percent. In some embodiments, the desiccant material may be incorporated into layer 22 at a level of approximately 30 weight percent.

In some embodiments, layer 32 may comprise a quantity of a masterbatch of polymer, buffer, and desiccant material. For example, the masterbatch may preferably comprise polyethylene having sodium bicarbonate and calcium oxide blended therein. Specifically, the masterbatch may comprise about 45 percent by weight polyethylene, about 5 percent by weight sodium bicarbonate and about 50 percent by weight calcium oxide. The masterbatch can be further blended into another polymeric material, such as low density polyethylene, in a ratio of about 60 percent by weight masterbatch and 40 percent by weight low density polyethylene. Therefore, layer 32, in some embodiments, may have a buffer content of 3.5 weight percent and a desiccant material content of about 35 weight percent in the layer 32. The amounts 3.5% and 35% respectively are based on the ratios listed for the masterbatch above when blended with resin at a ratio of 70% masterbatch and 30% resin.

Physical desiccants may also be used, and may effectively maintain fairly constant relative humidity levels within the headspace of a container including layer 32. The physical desiccants may include material such as molecular sieves or hydrate forming salt desiccants. Various levels of humidity may be maintained depending on the hydration levels or state of the hydrate forming salt within the polymer material. The physical desiccant may be molecular sieves, sodium phosphate di-basic, potassium carbonate, magnesium chloride or calcium sulfate. For instance a molecular sieve (zeolite) binds water within its pore space, whereas silica gel or clays having the ability to absorb water on their surfaces or within pore spaces of the material.

The desiccant employed may be anyone that is able to withstand the handling, blending, co-extrusion and blow-molding steps without deterioration, and it can be such that it has a drying effect that is consistent with the maximum moisture content to be permitted within the interior volume 18 according to the product to be packaged, as well as a suitable long-term activity.

The desirable size of the desiccant particles is dependent on the actual desiccant employed. For example, when CaO is used, particles having a size of less than about 0.003 inches in diameter can be used. Larger desiccant particle sizes can create a grainy appearance. However, in certain embodiments, larger desiccant particles can be used.

In some embodiments, layer 32 may comprise a quantity of a masterbatch of polymer, buffer, and a chemical desiccant material and a quantity of a masterbatch of polymer, buffer, and a physical desiccant material blended with another polymeric material.

In some embodiments, a buffer is present in the inner layer and the desiccant is present in a middle layer. As shown in FIG. 3, layer 41, the outer layer of container 11, can be made of any conventional as described above for outer layer 21 of FIG. 1. Layer 42, the inner layer of container 11, can comprise a buffer blended within a resin in a manner as described above for inner layer 22 of FIG. 1. A middle layer may be present comprising a desiccant blended with a resin.

The combined thicknesses of the two layers 21 and 22, or 31 and 32, or three layers 41, 42, and 43, can provide the container with the required rigidity and durability to meet commercial performance requirements. For example, when the resin employed in the layers is high density polyethylene, the outer layer 21 can have a thickness in the range of about 20 to 50 mils, and in a more particular embodiment about 30 mils, and the inner layer 22 can have a thickness in the range of about 10 to 25 mils, and in a more particular embodiment about 15 mils. The total thickness of the combined multiple layers 20 may be, for example, 45 mils. The total thickness can be less than or greater than embodiments above.

Closure or lid 12 may be a conventional closure or lid, e.g. a lid made of injection-molded high density polyethylene. In some embodiments, there would be no buffer or desiccant in the lid. In some embodiments, the lid 12 can contain a buffer with or without a desiccant and can be made of the same or similar double-layer structure as the container body 11, if desired. The closure can be of any suitable thickness.

In a further embodiment, the lid could have a buffer and the container have a desiccant, or the lid could have a desiccant and the container have a buffer.

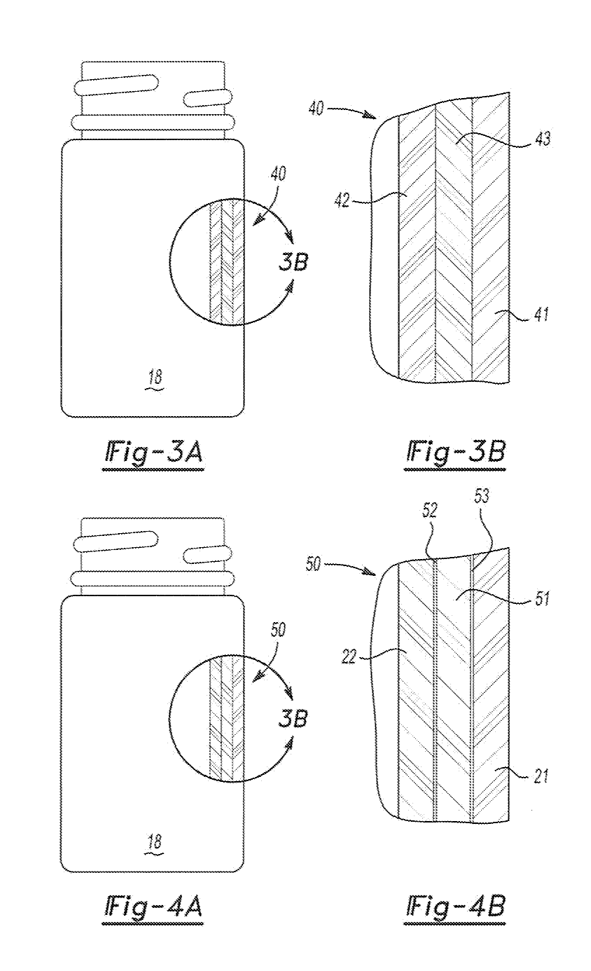

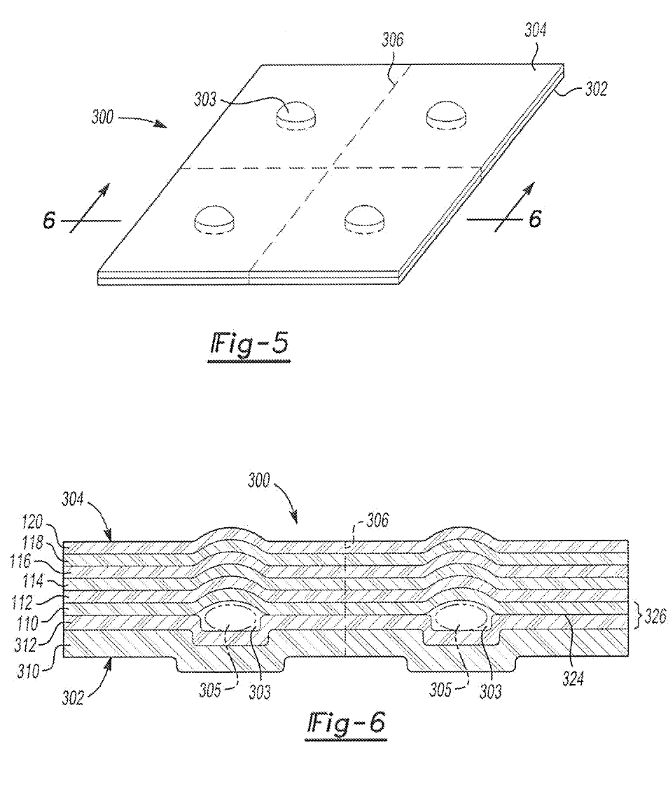

In some embodiments it is also possible to use three or more co-extruded layers to form the container 11. For example, inner layer 22 and outer layer 21 discussed above may be separated by a thin co-extruded intermediate layer 51 with a very high resistance to penetration by moisture. See FIGS. 4a and 4b. This further reduces moisture ingress into the container and thus extends the useful life of the desiccant and therefore the shelf life of the packaged product. While FIG. 4b shows intermediate layer 51 being thicker than inner layer 22, intermediate layer 51 can have the same thickness as inner layer 22, or be thinner than inner layer 22. In some embodiments, a suitable material for the intermediate layer can be, for example, polyvinylidene chloride, ethylene vinyl alcohol, or a fluoropolymer resin sold by Honeywell under the trademark Aclon, or polychlorotrlflu6roethylene (PCTFE) sold under the trademark Aclon. Intermediate layer 50 can comprise a material having a higher moisture resistance or a lower moisture resistance than the moisture-barrier material in the outer layer.

FIG. 4b also illustrates a container comprising more than three layers to form the container. As shown in FIG. 4b, an adhesive resin layer 52 can separate inner layer 22 and intermediate layer 51, and adhesive layer 53 can separate intermediate layer 51 and outer layer 21. Adhesive resin layers 51 and 52 can be made of any suitable resin that adheres to other resin layers. Examples of adhesive resins include but are not limited to Bynel® (by DuPont), Plexar® (by Equistar Chemical Company), and Admer® SF600 (by Mitsui Chemicals America, Inc.)

In another example of a container having three or more layers, one layer may comprises a buffer as discussed above, another layer comprises a desiccant as discussed in US Publication 20080012172, and a third layer is the outer layer as discussed previously.

Of course, the container need not be in the form of a bottle as shown in the drawings and may have any shape as required to accommodate a product to be packaged. FIGS. 5 and 6 illustrate a container 300 in an alternate embodiment of the present invention. More specifically, the container 300 may comprise a base structure 302 having multiple cavities 303 disposed therein for containing moisture-sensitive products therein. The base structure 302 may be formed having the same layers of materials as the bottle of FIG. 1, where layers 312 and 310 in FIG. 6 correspond to buffer layer 22 and outer layer 21 of FIG. 1, respectively. Further, the base structure 302 comprises cavities 303 for storing or otherwise containing the pH-sensitive products 305. The cavities 303 may preferably be formed in the base structure 302 using a thermoforming process or any other process for forming the cavities 303 in the base structure 302. The pH-sensitive products 305 may preferably be pharmaceutical or nutraceutical products, such as quick dissolve tablets or other quickly dissolving pharmaceuticals, although any other moisture-sensitive product is contemplated by the present invention.

The base structure 302 may be heat-sealed to a lidstock structure 304. The lidstock structure may have a film structure as shown in FIG. 6 having multiple layers, for example as illustrated by layers 110, 112, 114, 116, 118, 120. Specifically, a heat sealant layer 110 of the lidstock structure 304 may be heatsealed to buffer layer 312 of the base structure 302 that acts as a heat sealant layer for the base structure 302. The sealant layer 110 may also comprise the buffer material to prevent damage to any pH-sensitive products 305 contained therein. Moreover, the sealant layer 110 may further comprise a peelable seal component to allow a seal formed by heat sealing the desiccant lidstock structure 304 to the base structure 302 to be easily peelable. For example, the sealant layer 110 may comprise polybutene, DuPont APPEEL® modified polymeric resin that allows the sealant layer 110 to separate from the forming layer 312 of the base structure 302 using digital pull-apart forces. One or more additional layers are present for example, FIG. 6 illustrates a six layer structure as is within the skill of the art.

The container 300 may have perforations 306 such that the peelable film may only expose one cavity containing the pH-sensitive product when the sealant film is peeled from the base structure. When the peelable sealant film structure is peeled from the base structure, the peelable sealant film structure may break at the perforations 306, thereby maintaining the barrier properties of the other products contained within the other cavities. The perforations 306 may alternately go all the way through the package 300 such that each individual cavity may be removed from the remaining cavities within the package by breaking the container 300 at the perforations 306.

Layers 22, 32, or 42 can be U.S. FDA and regulatory compliant for direct contact with food or drug products to be placed within open space defined by the container.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multilayer container for storing pH-sensitive products comprising:
a buffer layer comprising a first polymeric material and a buffer; and
an outer layer comprising a second polymeric material.

2. The multilayer container of claim 1, wherein the buffer layer further comprises at least one desiccant selected from chemical desiccants, physical desiccants, and combinations thereof.

3. The multilayer container of claim 2, wherein the desiccant is selected from calcium oxide or magnesium sulfate.

4. The multilayer container of claim 1, further comprising a middle layer disposed between the buffer layer and the outer layer.

5. The multilayer container of claim 4, wherein the middle layer comprises at least one desiccant selected from chemical desiccants, physical desiccants, and combinations thereof.

6. The multilayer container of claim 4, wherein the middle layer comprises a barrier material selected from the group consisting of a fluoropolymer, polyvinylidene chloride and ethylene vinyl alcohol.

7. The multilayer container of claim 1, wherein the buffer is selected from sodium bicarbonate, ethanoic acid, sodium ethanoate, acetic acid, and combinations thereof.

8. The multilayer container of claim 1, wherein the first polymeric material is selected from the group consisting of linear low density polyethylene, high density polyethylene, polyethylene, cellulose acetate butyrate, ethyl cellulose, polycarbonate, nylon 6, polysulfone, polyether sulfone and cyclic olefin copolymers.

9. The multilayer container of claim 1, wherein the second polymeric material is selected from the group, consisting of high density polyethylene, polypropylene, medium density polyethylene, cyclic olefins, cyclic olefin copolymers and polyethylene terephthalate.

10. The multilayer container of claim 1, wherein the buffer is present at a range of from about 0.01 to about 5 weight percent of the buffer layer.

11. The multilayer container of claim 1, wherein the buffer layer further comprises a foaming agent.

12. A multilayer container for storing pH-sensitive products comprising:
a buffer layer comprising a first polymeric material and a buffer, wherein the buffer is present at a range of from about 0.01 to about 5 weight percent of the desiccant layer;
an outer, layer comprising high density polyethylene; and
a middle layer comprising a barrier material.

13. The multilayer container of claim 12, wherein the buffer layer further comprises a foaming agent.

14. The multilayer container of claim 12, wherein the barrier material is selected from the group consisting of a fluoropolymer, polyvinylidene chloride and ethylene vinyl alcohol.

15. A multilayer container for storing pH-sensitive products comprising:
a buffer layer comprising a first polymeric material, a foaming agent and a buffer;
an outer layer comprising a second polymeric material; and
a desiccant layer disposed between the buffer layer and the outer layer, the desiccant layer comprising calcium oxide.

16. A method for making a multilayer container, comprising:
providing a first masterbatch comprising a buffer and a first polymeric material;
providing a second masterbatch comprising a second polymeric material;
blending the first masterbatch and the second masterbatch with a third polymeric material to form a subsequent blend;
forming the subsequent blend and high density polyethylene into a preform via co-extrusion or via co-injection molding; and
blow-molding the preform to form the container.

17. The method of claim 16, wherein the buffer is present at a range of from about 0.01 to about 5 weight percent of the subsequent blend.

18. The method of claim 16, wherein the step of blending further comprises blending a foaming agent with the first masterbatch, the second masterbatch and the third polymeric material.

19. The method of claim 16, wherein the step of forming comprises forming a shape selected from the group consisting of a bottle, a vial, and a formed sheet with lidstock.

20. The method of claim 16, wherein the step of forming further comprises including a barrier layer between the subsequent blend and the high density polyethylene.

21. The method of claim 16, wherein the step of forming further comprises including a desiccant layer between the subsequent blend and the high density polyethylene, the desiccant layer comprising calcium oxide.
